(19) United States
(12) Patent Application Publication
(10) Pub. No.: US 2023/0410383 A1
(43) Pub. Date: Dec. 21, 2023

(54) DISPLAY CONTROL DEVICE, DISPLAY DEVICE, DISPLAY SYSTEM, VEHICLE, DISPLAY CONTROL METHOD, AND NON-TRANSITORY STORAGE MEDIUM

(71) Applicant: TOYOTA JIDOSHA KABUSHIKI KAISHA, Toyota-shi (JP)

(72) Inventors: Toshinori AOKI, Toyota-shi (JP); Norihisa HOTTA, Nagoya-shi (JP); Takahiro HIROTA, Aichi-ken (JP)

(21) Appl. No.: 18/317,153

(22) Filed: May 15, 2023

(30) Foreign Application Priority Data
Jun. 16, 2022 (JP) 2022-097653

(51) Int. Cl. G06T 11/00; G06T 7/70; G06T 3/40; B60K 35/00

(52) U.S. Cl. CPC G06T 11/00; G06T 7/70; G06T 3/40; B60K 35/00; G06T 2207/30261; B60K 2370/152; B60K 2370/178; B60K 2370/21; B60K 2370/193

(57) ABSTRACT

A display control device comprises a memory; and a processor coupled to the memory. The processor is configured to acquire positional information related to a position of a target based on detection information of the target detected in surroundings of a vehicle, acquire velocity information related to a velocity of the vehicle, acquire an approach direction along which the target approaches the vehicle, offset the positional information in the approach direction based on the velocity information, and generate a mark urging caution with respect to the target for overlay display on a display area provided in a cabin of the vehicle based on the positional information that has been offset.

### CROSS-REFERENCE TO RELATED APPLICATION

This application is based on and claims priority under 35 USC 119 from Japanese Patent Application No. 2022-097653 filed on Jun. 16, 2022, the disclosure of which is incorporated by reference herein.

### BACKGROUND

### Technical Field

The present disclosure relates to a display control device, a display device, a display system, a vehicle, a display control method, and a non-transitory storage medium.

### Related Art

In a hitherto known display device such as a head up display, a virtual image of an augmented reality (AR) image is overlay displayed on a scene in front of a vehicle by projecting an image onto a front windshield or the like of the vehicle.

For example, Japanese Patent No. 6278222 discloses technology including a caution target detection section that detects a caution target needing caution to be raised for a driver of a vehicle and that computes a distance from the caution target to the vehicle, and a display control section that performs adjacent display of a caution mark to raise the caution of the driver in respect to the caution target detected by the caution target detection section at a position separated from the caution target on the front glass by a specific distance as viewed by the driver. The display control section changes the specific distance according to the distance from the caution target to the vehicle so as to change the display position of the caution mark, and corrects the display position of the caution mark according to a time difference from when the caution target is detected until the caution mark is displayed, and also corrects the specific distance according to the velocity of the vehicle when the caution target was detected.

In the configuration described above, the display position of the caution mark is corrected according to the time difference from when the caution target is detected until the caution mark is displayed, and also the specific distance is corrected according to the velocity of the vehicle when the caution target was detected, thereby enabling the caution mark to be displayed at a suitable position irrespective of the time difference until the caution mark is displayed and irrespective of the velocity of the vehicle.

However, the technology disclosed in Japanese Patent No. 6278222 is technology in which the distance of the caution mark from the caution target is changed and the display position of the mark is corrected according to the time difference from when the caution target is detected until the caution mark is displayed, and according to the velocity of the vehicle when the caution target was detected, and so there is room for improvement since positional misalignment still occurs as before between the caution target and the caution mark.

### SUMMARY

The present disclosure appropriately corrects positional misalignment occurring between a position for overlay display of a mark urging caution with respect to a target and the actual position of the target.

A display control device according to a first aspect includes a positional information acquisition section that acquires positional information related to a position of a target based on detection information of a target detection section for detecting the target in surroundings of a vehicle, a velocity information acquisition section that acquires velocity information related to a velocity of the vehicle, an approach direction acquisition section that acquires an approach direction along which the target approaches the vehicle, an offset section that offsets the positional information acquired by the positional information acquisition section in the approach direction acquired by the approach direction acquisition section based on the velocity information acquired by the velocity information acquisition section, and a mark generation section that generates a mark urging caution with respect to the target for overlay display on a display area provided in a cabin of the vehicle based on post offset positional information that has been offset by the offset section.

In the display control device according to the first aspect the mark is generated at a position offset from the position of the target acquired by the positional information acquisition section based on the velocity information, such that the mark urging caution with respect to the target is generated at a position of the position of the target acquired by the positional information acquisition section offset according to the velocity. This enables correction of positional misalignment between where the mark is overlay displayed and the actual target occurring due to the processing time from detection of the target by the target detection section until the mark is generated by the mark generation section.

Moreover, by offsetting the position of the target acquired by the positional information acquisition section in the approach direction along which the target approaches, the position of the target acquired by the positional information acquisition section is offset in a direction in which positional misalignment occurs between the overlay displayed mark and the actual target. This accordingly enables positional misalignment occurring between the position for overlay display of a mark urging caution with respect to a target and the actual position of the target to be corrected appropriately. As a result thereof, the position of the overlay displayed mark can be brought closer to the actual position of the target.

A display control device according to a second aspect is the display control device of the first aspect wherein the velocity information is information related to an absolute velocity of the vehicle in a case in which the approach direction acquired by the approach direction acquisition section is a progression direction of the vehicle.

In the display control device according to the second aspect, the velocity information is taken as being the absolute velocity of the vehicle, and the velocity information is acquired by detecting the velocity of the vehicle. This thereby enables the velocity information to be acquired quicker than in a case in which the velocity information is taken as being the relative velocity of the vehicle with respect to the target. As a result thereof, the time taken by the offset section to offset the position of the target acquired by the positional information acquisition section can be shortened. Moreover, the load on the CPU installed in the display control device can be lightened. This means that positional misalignment occurring between the position for overlay display of a mark urging caution with respect to a target and the actual position of the target can be corrected more appropriately.

A display control device according to a third aspect is the display control device of the first aspect, wherein the velocity information is information related to a relative velocity of the vehicle with respect to the target in a case in which the approach direction acquired by the approach direction acquisition section is an oblique direction at an angle with respect to a progression direction of the vehicle.

In the display control device according to the third aspect, the velocity information is taken as being the relative velocity of the vehicle with respect to the target, and an offset distance for the offset section to offset the position of the target acquired by the positional information acquisition section is appropriately set based on this relative velocity. This means that positional misalignment occurring between the position for overlay display of a mark urging caution with respect to a target and the actual position of the target can be corrected more appropriately.

A display control device according to a fourth aspect is the display control device of any one of the first aspect to the third aspect, wherein the offset section adjusts an offset distance with which the offset section offsets the positional information based on a processing time from detection of the target by the target detection section until generation of the mark.

In the display control device according to the fourth aspect, the offset distance with which to offset the position of the target acquired by the positional information acquisition section is adjusted based on the processing time from detection of the target by the target detection section until generation of the mark, such that the offset distance is large when the processing time is long, and the offset distance is small when the processing time is short. This means that the offset distance with which the offset section offsets the position of the target acquired by the positional information acquisition section is set appropriately according to the processing time. As a result thereof, the position of the mark for overlay display can be corrected to an appropriate position according to the processing time.

A display control device according to a fifth aspect is the display control device of any one of the first aspect to the fourth aspect, wherein the positional information acquisition section acquires positional information related to a position of the target in the progression direction of the vehicle based on detection information of a radar, and acquires positional information related to the position of the target in an orthogonal direction orthogonal to the progression direction of the vehicle based on a camera image of a camera.

In the display control device according to the fifth aspect, the vehicle progression direction positional information of the target in the progression direction of the vehicle is acquired by the detection information of the radar, and the vehicle orthogonal direction positional information of the target in the orthogonal direction orthogonal to the progression direction of the vehicle is acquired based on the camera image of the camera. This means that more accurate positional information of the target is acquired. As a result thereof, positional misalignment occurring between the position for overlay display of a mark urging caution with respect to a target and the actual position of the target can be corrected more appropriately.

A display control device according to a sixth aspect is the display control device of any one of the first aspect to the fifth aspect, wherein the mark generation section changes a size of the mark based on the positional information acquired by the positional information acquisition section.

In the display control device according to the sixth aspect, the size of the mark is changed based on the positional information acquired by the positional information acquisition section, such that the size of the mark is large when the distance between the vehicle and the target is near, and the size of the mark is small when the distance between the vehicle and the target is far. This thereby enables the mark to be overlay displayed at an appropriate size according to the distance to the target. As a result thereof an occupant is able to ascertain the distance to the target from the size of the mark.

A display device according to a seventh aspect includes the display control device of any one of the first aspect to the sixth aspect, an output section that outputs an image of the mark for overlay display on the display area provided in the vehicle cabin, and a display area on which the image output from the output section is overlay displayed.

In the display device according to the seventh aspect, positional misalignment occurring between the position for overlay display of a mark urging caution with respect to a target and the actual position of the target can be corrected appropriately.

A display system according to an eighth aspect includes the display device of the seventh aspect, and a target detection section for detecting the target in surroundings of the vehicle.

In the display system according to the eighth aspect, positional misalignment occurring between the position for overlay display of a mark urging caution with respect to a target and the actual position of the target can be corrected appropriately.

A vehicle according to a ninth aspect includes the display system of the eighth aspect, and a windshield configuring the display area.

In the vehicle according to the ninth aspect, the mark is displayed on the display area of the windshield, and so an occupant is aware of the mark in a state of gazing in the vehicle forward direction. This accordingly enables the occupant to be aware of the mark during driving without shifting from a vehicle forward direction gaze.

A display control method executed by a processor according to a tenth aspect includes, by a processor, acquiring positional information related to a position of a target based on detection information of a target detection section for detecting the target in surroundings of a vehicle, acquiring velocity information related to a velocity of the vehicle, acquiring an approach direction along which the target approaches the vehicle, offsetting the positional information in the approach direction based on the velocity information, and generating a mark urging caution with respect to the target for overlay display on a display area provided in a cabin of the vehicle based on the positional information that has been offset.

The display control method executed by a processor according to the tenth aspect enables positional misalignment occurring between a position for overlay display of a mark urging caution with respect to a target and the actual position of the target to be corrected appropriately.

A non-transitory storage medium according to an eleventh aspect stores a program executable by a processor to perform display control processin. The processing includes acquiring positional information related to a position of a target based on detection information of a target detection section for detecting the target in surroundings of a vehicle, acquiring velocity information related to a velocity of the vehicle, acquiring an approach direction along which the target approaches the vehicle, offsetting the positional information in the approach direction based on the velocity information, and generating a mark urging caution with respect to the target for overlay display on a display area provided in a cabin of the vehicle based on the positional information that has been offset.

The non-transitory storage medium according to the eleventh aspect enables positional misalignment occurring between a position for overlay display of a mark urging caution with respect to a target and the actual position of the target to be corrected appropriately.

The present disclosure enables positional misalignment occurring between a position for overlay display of a mark urging caution with respect to a target and the actual position of the target to be corrected appropriately.

### BRIEF DESCRIPTION OF THE DRAWINGS

Exemplary embodiments of the present invention will be described in detail based on the following figures, wherein:

FIG. 1 is a bird's eye view illustrating a vehicle installed with a display system according to a first exemplary embodiment;

FIG. 2 is a schematic diagram illustrating a vehicle installed with a display system according to the first exemplary embodiment, and schematically illustrates a state viewing a front side of the vehicle from inside the vehicle cabin;

FIG. 3 is a block diagram illustrating a hardware configuration of a display system according to the first exemplary embodiment;

FIG. 4 is a block diagram illustrating a functional configuration of a display control device according to the first exemplary embodiment;

FIG. 5 is a bird's eye view illustrating a vehicle installed with a display system according to the first exemplary embodiment, and is a diagram illustrating a case in which an approach direction of a target is a vehicle progression direction;

FIG. 6 is a bird's eye view illustrating a vehicle installed with a display system according to the first exemplary embodiment, and is a diagram illustrating a case in which an approach direction of a target is an oblique direction at an angle with respect to a vehicle progression direction;

FIG. 7 is a diagram illustrating an example of a display on a display area of a display device according to the first exemplary embodiment, and is a diagram illustrating a case in which an approach direction of a target is a vehicle progression direction;

FIG. 8 is a diagram illustrating an example of a display on a display area of a display device according to the first exemplary embodiment, and is a diagram illustrating a case in which an approach direction of a target is an oblique direction at an angle with respect to a vehicle progression direction;

FIG. 9 is a diagram illustrating an example of a display on a display area of a display device according to the first exemplary embodiment, and is a diagram illustrating a case in which a target is at a far position;

FIG. 10 is a flowchart illustrating a flow of display processing of a display control device according to the first exemplary embodiment;

FIG. 11 is a diagram illustrating an example of a display on a display device of a comparative example, and is a diagram illustrating a case in which an approach direction of a target is a vehicle progression direction;

FIG. 12 is a diagram illustrating an example of a display on a display device of a comparative example, and is a diagram illustrating a case in which an approach direction of a target is an oblique direction at an angle with respect to a vehicle progression direction; and

FIG. 13 is a diagram illustrating an example of a display of a display device according to a second exemplary embodiment.

### DETAILED DESCRIPTION

### First Exemplary Embodiment

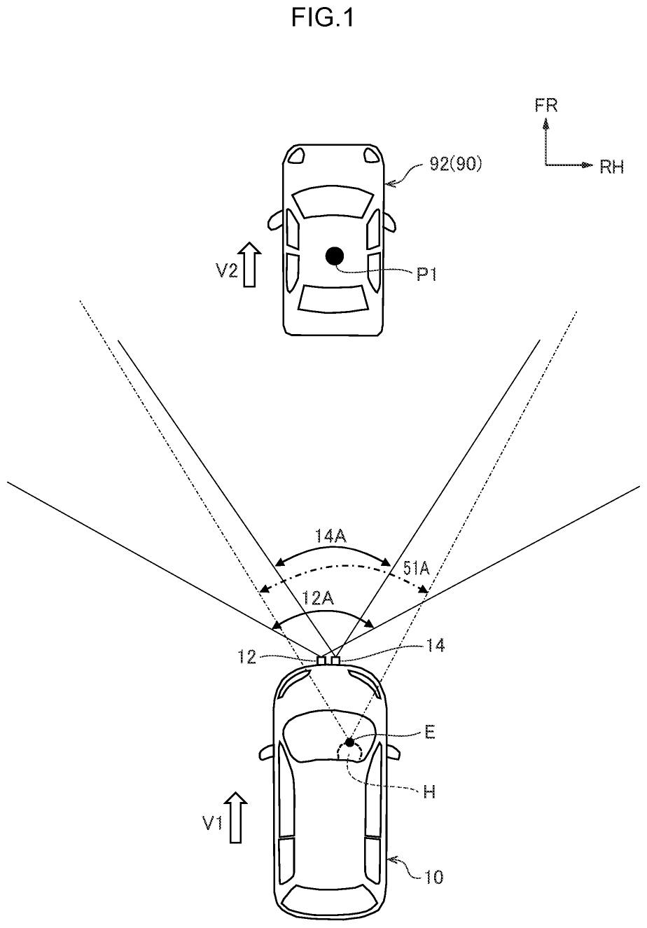

Description follows regarding a display system according to a first exemplary embodiment, with reference to the drawings. Note that an arrow FR in FIG. 1 indicates a vehicle forward direction, and an arrow RH indicates a vehicle right side. Moreover, in the first exemplary embodiment an example will be described in which a vehicle 10 is traveling at a velocity V1 in the vehicle forward direction.

Configuration of Display System Installed Vehicle

As illustrated in FIG. 1, the vehicle 10 is provided with a camera 12 as a target detection section, and with a radar 14 as a target detection section. The camera 12 is attached to a bumper at a front side of the vehicle 10, and images ahead of the vehicle. The camera 12 may be configured to have an angle of view 12A.

The radar 14 is attached to the bumper at a front side of the vehicle 10. In the radar 14, transmission waves that have been transmitted so as to hit a target 90 in the surroundings of the vehicle 10 are received as reflection waves reflected by the target 90, so as to detect both a distance between the vehicle 10 and the target 90 and the direction of the target 90 with respect to the vehicle 10. Namely, the radar 14 detects positional information of the target 90 with respect to the vehicle 10. The radar 14 has a smaller angle of view 14A than the angle of view 12A of the camera 12.

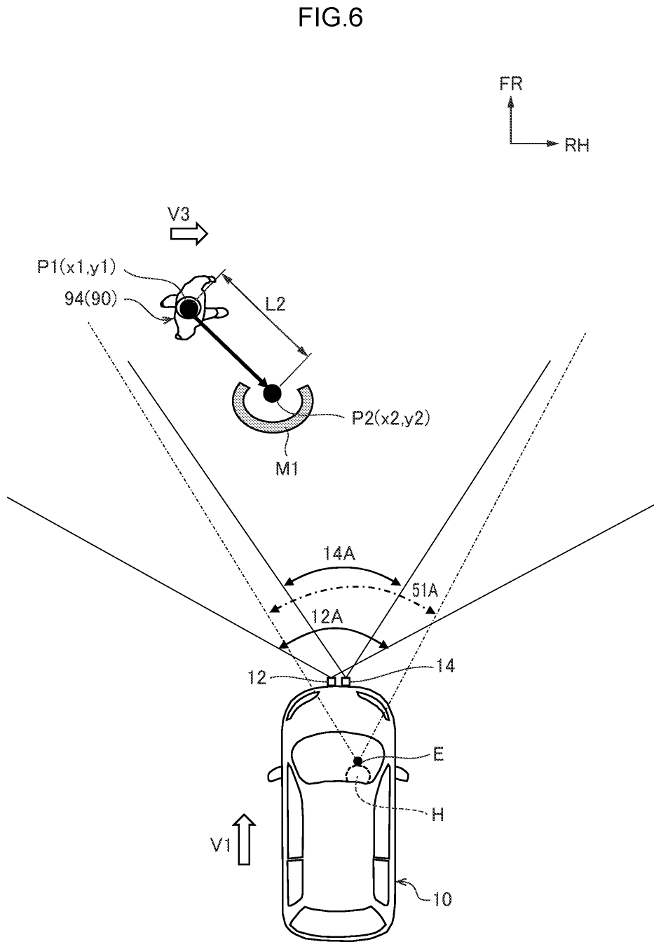

A vehicle ahead 92 (see FIG. 1) traveling ahead of the vehicle, a pedestrian 94 (see FIG. 6) and a bicycle, an oncoming vehicle traveling in the opposing traffic lane, a vehicle that has parked up, or other obstruction may be taken as examples of the target 90.

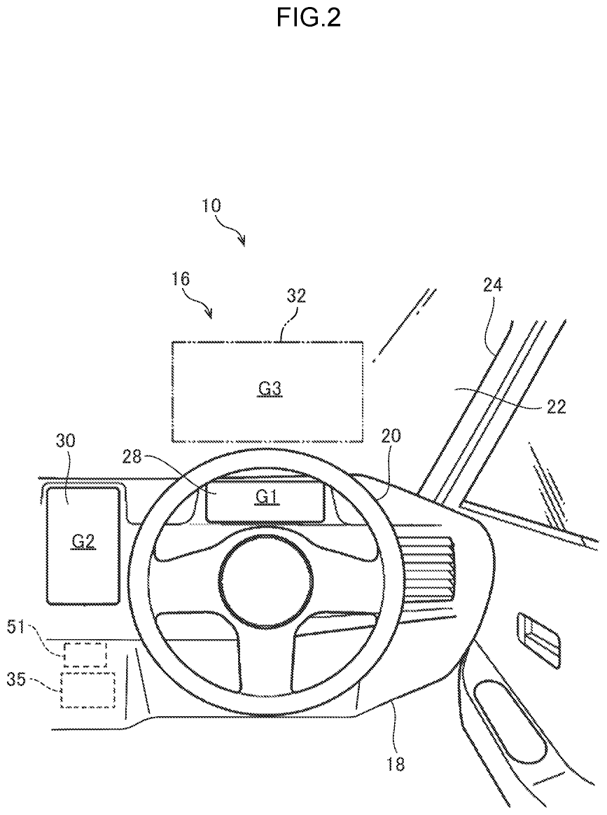

As illustrated in FIG. 2, an instrument panel 18 and a windshield (also called front glass) 22 are provided at a front side of a vehicle cabin of the vehicle 10.

Instrument Panel

The instrument panel 18 is provided extending along a vehicle width direction. A steering wheel 20 is provided at a vehicle right side of the instrument panel 18. In the first exemplary embodiment, as an example, the vehicle 10 is configured as a right hand drive vehicle in which the steering wheel 20 is provided on the vehicle right side.

The instrument panel 18 is provided with a first display section 28 serving as an output section and including a first display area G1 serving as a display area, and a second display section 30 serving as an output section and including a second display area G2 serving as a display area.

The first display section 28 is disposed on the vehicle right side of the instrument panel 18 and at a vehicle forward direction side of the steering wheel 20. The first display section 28 is, for example, configured as a meter display on which a speedometer to show the traveling velocity, a direction indicator, a warning or the like are displayed.

The second display section 30 is disposed at a vehicle width direction center of the instrument panel 18. The second display section 30 is, for example, configured as a center display for displaying an image output from a navigation system.

Windshield

The windshield 22 is supported by front pillars 24. The front pillars 24 are respectively disposed at the vehicle right side and vehicle left side at a vehicle front side of the vehicle cabin, and extend in directions substantially along a vehicle height direction.

A third display section 32 including a third display area G3 serving as a display area is provided on the windshield 22. Based on information output from a display control device 35 inbuilt to the instrument panel 18, an image projected from a projection section 51 serving as an output section is projected onto the third display section 32 of the windshield 22. An image is thereby overlay displayed as a virtual image ahead of an occupant (driver) H (see FIG. 1).

A display device 34 equipped with the display control device 35, the projection section 51, and the third display section 32 configures a head up display device. The third display section 32 onto which the image from the projection section 51 is projected configures a projection surface of the head up display device.

The projection section 51 is, as illustrated in FIG. 1, configured to have an angle of view 51A smaller than the angle of view 12A. The angle of view 51A of the projection section 51 is configured such that the eyepoint E of the occupant H is at a virtual origin. The angle of view 51A of the projection section 51 is an angular range where an image is displayable on the third display area G3.

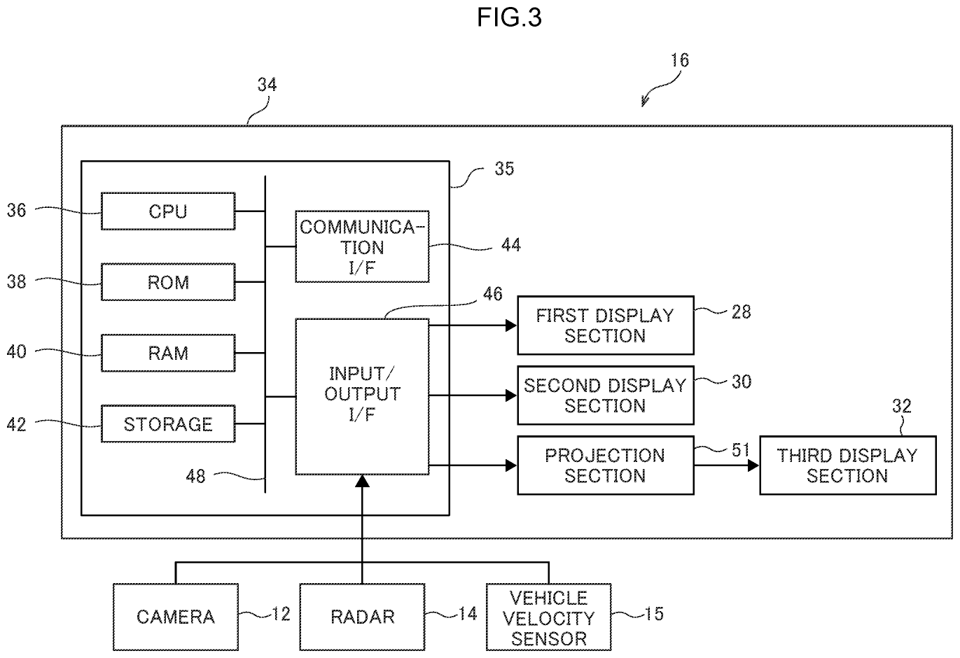

As illustrated in FIG. 3, the display device 34, the camera 12, the radar 14, and a vehicle velocity sensor 15 configure a display system 16.

Display System Hardware Configuration

As illustrated in FIG. 3, the display system 16 is configured such that a camera image imaged by the camera 12, detection information detected by the radar 14, and measurement information measured by the vehicle velocity sensor 15, are input to the display control device and such that processing information processed by the display control device 35 is output to the first display section 28, the second display section 30, and the projection section 51.

The camera 12 images ahead of the vehicle. The camera images ahead of the vehicle imaged by the camera 12 are input to the display control device 35. The radar 14 detects positional information of the target 90 ahead of the vehicle. The detection information detected by the radar 14 is input to the display control device 35. The vehicle velocity sensor 15 measures the velocity V1 of the vehicle 10 (see FIG. 1). The information of the velocity V1 of the vehicle 10 as measured by the vehicle velocity sensor 15 is input to the display control device 35.

The display control device 35 is configured as an electronic control unit (ECU) that performs various controls. The display control device 35 is configured including a central processing unit (CPU) 36, read only memory (ROM) 38, random access memory (RAM) 40, storage 42, a communication interface (communication I/F) 44, and an input/output interface (input/output I/F) 46. Each configuration element is connected to a bus 48 so as to enable communication with each other.

The CPU 36 is a central processing unit that executes various programs and controls each section. Namely, the CPU 36 serves as a processor, reads a program from the ROM 38 serving as memory or from the storage 42 serving as memory, and executes the program using the RAM 40 as workspace. Moreover, the CPU 36 controls each of the above configuration elements and performs various computational processing according to the program recorded in the ROM 38 or the storage 42.

The ROM 38 is stored with various programs and various data. The RAM 40 serves as workspace to temporarily store a program and/or data. The storage 42 is configured by a hard disk drive (HDD) or solid state drive (SSD), and is a non-transitory recording medium stored with various programs including an operating system, and various data. In the first exemplary embodiment, a display program and the like for performing display processing, described later, is stored in the ROM 38 or the storage 42.

The first display section 28, the second display section 30, the projection section 51, the camera 12, the radar 14, and the vehicle velocity sensor 15 are connected to the input/output interface 46.

Display Control Device Functional Configuration

Description follows regarding functionality of the display control device 35 of the first exemplary embodiment.

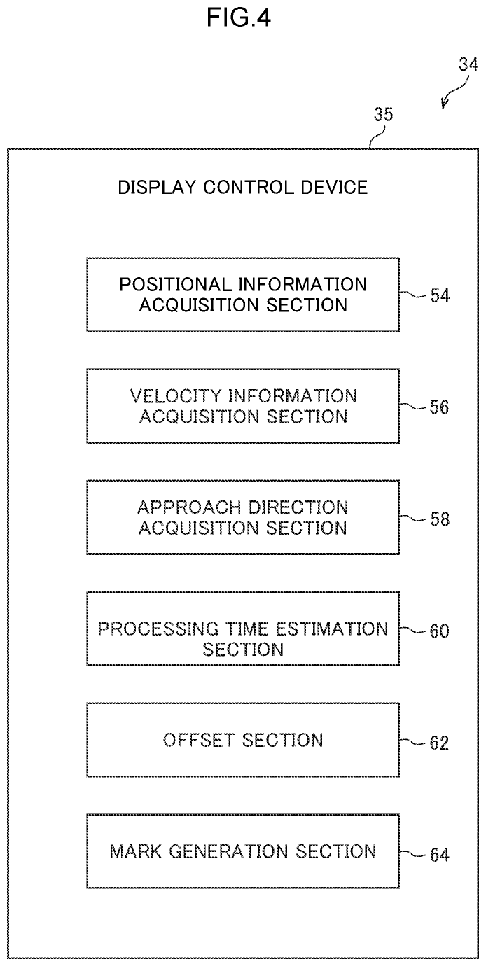

As illustrated in FIG. 4, the display control device 35 is configured functionally by a positional information acquisition section 54, a velocity information acquisition section 56, an approach direction acquisition section 58, a processing time estimation section 60, an offset section 62, and a mark generation section 64. Note that each functional configuration illustrated in FIG. 4 is, for example, implemented by the CPU 36 executing a program stored in the ROM 38 or the storage 42.

Positional Information Acquisition Section

The positional information acquisition section 54 acquires positional information related to a position of the target 90 in surroundings of the vehicle 10. More specifically, the positional information acquisition section 54 detects the positional information of the target in the progression direction of the vehicle 10 based on the detection information of the radar 14. Moreover, the positional information acquisition section 54 detects positional information of the target 90 in an orthogonal direction orthogonal to the progression direction of the vehicle 10 based on a camera image of the camera 12. Note that vehicle progression direction positional information of the target 90 in the progression direction of the vehicle 10 and vehicle orthogonal direction positional information of the target 90 in the orthogonal direction of the vehicle 10 may be detected based on at least one of the detection information of the radar 14 or the camera image of the camera 12.

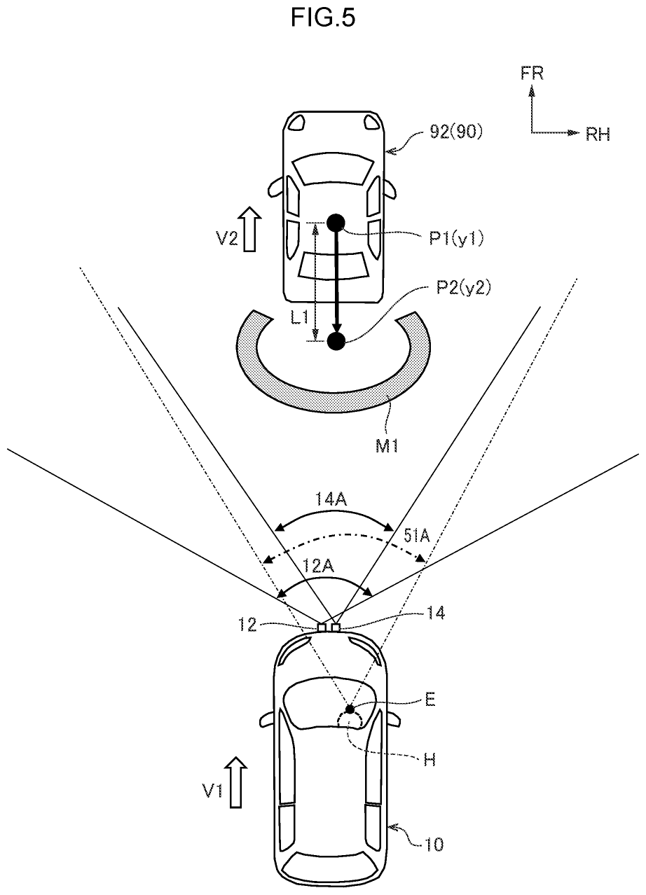

An xy coordinate system is presumed here in which, when the vehicle 10 is in a bird's eye view, the vehicle progression direction is the y axis, and a direction orthogonal to the vehicle progression direction is the x axis. As illustrated in FIG. 5, in a case in which there is a vehicle ahead 92 traveling forward ahead of the vehicle 10, based on detection information of the radar 14, the positional information acquisition section 54 detects a y coordinate of a position P1 of the vehicle ahead 92 in the progression direction of the vehicle as the vehicle progression direction positional information. Namely, the positional information acquisition section 54 acquires the position P1 (y1) of the vehicle ahead 92 based on the detection information of the radar 14. Note that in FIG. 5 the vehicle ahead 92 is traveling at a velocity V2 in a forward direction.

As illustrated in FIG. 6, in a case in which there is a pedestrian 94 moving toward the vehicle right side obliquely to the left and in front of the vehicle 10, the positional information acquisition section 54 detects, as the vehicle progression direction positional information, a y coordinate of the position P1 of the pedestrian 94 in the progression direction of the vehicle based on the detection information of the radar 14, and detects, as the vehicle orthogonal direction positional information, an x coordinate of the position P1 of the pedestrian 94 in the orthogonal direction orthogonal to the progression direction of the vehicle 10 based on a camera image of the camera 12.

Namely, the positional information acquisition section 54 acquires the position P1 (x1, y1) of the pedestrian 94 based on the detection information of the radar 14 and the camera image of the camera 12. Note that in FIG. 6 the pedestrian 94 is moving at a velocity V3 toward the vehicle right.

Velocity Information Acquisition Section

The velocity information acquisition section 56 acquires velocity information related to the velocity of the vehicle 10. The velocity information includes information about the absolute velocity of the vehicle 10, and information about the relative velocity of the vehicle with respect to the target 90.

More specifically, as illustrated in FIG. 5, in a case in which the vehicle ahead 92 is traveling in a forward direction ahead of the vehicle 10, the velocity information acquisition section 56 acquires a velocity V1 that is an absolute velocity of the vehicle 10 based on measurement information of the vehicle velocity sensor 15.

As illustrated in FIG. 6, in a case in which a pedestrian 94 is moving toward the vehicle right side obliquely to the left and in front of the vehicle 10, the velocity information acquisition section 56 computes a shift in the positional information of the pedestrian 94 based on plural camera images imaged by the camera 12, and based on this shift acquires a relative velocity of the pedestrian 94 with respect to the vehicle 10. In other words, the velocity information acquisition section 56 is able to acquire the relative velocity of the pedestrian 94 with respect to the vehicle 10 based on a change in position of the pedestrian 94 when the camera images of the camera 12 are arranged in a time series.

Note that in a case in which the pedestrian 94 is moving toward the vehicle right side obliquely to the left and in front of the vehicle 10, the velocity information acquisition section 56 may compute a shift in the positional information of the pedestrian 94 based on plural detection information detected by the radar 14, and based on this shift acquire a relative velocity of the pedestrian 94 with respect to the vehicle 10.

Approach Direction Acquisition Section

The approach direction acquisition section 58 acquires an approach direction along which the target 90 approaches the vehicle 10. More specifically, based on plural camera images imaged by the camera 12, the approach direction acquisition section 58 computes a shift in positional information of the target 90, and based on this shift acquire an approach direction of the target 90 with respect to the vehicle 10. Note that the approach direction acquisition section 58 may compute a shift in positional information of the target 90 based on plural detection information detected by the radar 14, and based on this shift acquire an approach direction of the target 90 with respect to the vehicle 10.

As illustrated in FIG. 5, in a case in which a vehicle ahead 92 is traveling in a forward direction ahead of the vehicle 10, the approach direction acquisition section 58 acquires an approach direction of the vehicle ahead 92 with respect to the vehicle 10 based on plural detection information detected by the radar 14 as a progression direction of the vehicle 10. Note that in a case in which the vehicle ahead 92 is traveling in a forward direction ahead of the vehicle 10, the approach direction acquisition section 58 may acquire the approach direction of the vehicle ahead 92 with respect to the vehicle 10 based on plural camera images imaged by the camera 12 as the progression direction of the vehicle 10.

Note that cases in which the approach direction is taken as being the progression direction of the vehicle 10 include cases in which the vehicle ahead 92 is at a different position to the vehicle 10 in a vehicle width direction, and also cases in which the vehicle ahead 92 is traveling forward or backward. Namely, cases in which the approach direction is taken as being the progression direction of the vehicle 10 include cases in which the vehicle ahead 92 is traveling forward or backward and the vehicle ahead 92 is at the same position as the vehicle 10 in the vehicle width direction, and cases in which the vehicle ahead 92 is traveling forward or backward at a different position to the vehicle 10 in the vehicle width direction.

As illustrated in FIG. 6, in a case in which there is a pedestrian 94 moving toward the vehicle right side obliquely to the left and in front of the vehicle 10, the approach direction acquisition section 58 may acquire the approach direction of the pedestrian 94 with respect to the vehicle 10 as an oblique direction at an angle with respect to the progression direction of the vehicle 10 based on the plural camera images imaged by the camera 12. An oblique direction at an angle with respect to the progression direction of the vehicle 10 includes a direction orthogonal to the progression direction of the vehicle 10.

Note that in a case in which the pedestrian 94 is moving toward the vehicle right side obliquely to the left and in front of the vehicle 10, the approach direction acquisition section 58 may acquire the approach direction of the pedestrian 94 with respect to the vehicle 10 as an oblique direction at an angle with respect to the progression direction of the vehicle 10 based on plural detection information detected by the radar 14.

Processing Time Estimation Section

The processing time estimation section 60 estimates a processing time from when the camera 12 images the target 90, or from when the radar 14 detects the target 90, until a mark M1 (see FIG. 5) urging caution with respect to the target 90 is generated by the mark generation section 64. More specifically, the processing time estimation section 60 may estimate the processing time according to load on the CPU 36. For example, the processing time estimation section 60 may estimate the processing time to be longer the greater the load on the CPU 36.

Moreover, in a case in which the approach direction acquired by the approach direction acquisition section 58 is the progression direction of the vehicle 10, the processing time estimation section 60 may estimate the processing time to be shorter than cases in which the approach direction is an oblique direction at an angle with respect to the progression direction of the vehicle 10. Moreover, the processing time estimation section 60 may estimate the processing time to be shorter the slower the velocity information acquired by the velocity information acquisition section 56.

Offset Section

Based on the velocity information acquired by the velocity information acquisition section 56, the offset section 62 offsets a position P1 of the target 90 acquired by the positional information acquisition section 54 by offsetting in the approach direction acquired by the approach direction acquisition section 58.

More specifically, the offset section 62 estimates an offset distance for offset based on the following computation equation (1).

offset distance (m)=velocity (km/h)×target coordinate coefficient (1)
target coordinate coefficient=0.00005

The target coordinate coefficient is a coefficient that takes into consideration the processing time taken from when the camera 12 images the target 90, or from when the radar 14 detects the target 90, until the mark M1 (see FIG. 5) urging caution with respect to the target 90 is generated by the mark generation section 64. The target coordinate coefficient may, for example, be set such that the offset distance is 3 to 5 m when the processing time is estimated to be 200 milliseconds in a case in which the target 90 is approached at a velocity V1 of the vehicle 10 of 60 km/h.

Note that the offset section 62 may adjust the offset distance to offset the position P1 acquired by the positional information acquisition section 54 according to the processing time estimated by the processing time estimation section 60. More specifically, in a case in which the processing time estimated by the processing time estimation section 60 is short, the offset section 62 may shorten the offset distance for offsetting compared to cases in which the processing time is long. Namely, the target coordinate coefficient may be caused to vary according to the processing time estimated by the processing time estimation section 60.

More precisely, in a case in which the vehicle ahead 92 is traveling forward ahead of the vehicle 10 as illustrated in FIG. 5, based on the velocity V1 that is the absolute velocity of the vehicle 10 acquired by the velocity information acquisition section 56, the offset section 62 offsets the position P1 (y1) acquired by the positional information acquisition section 54 by an offset distance L1 in the progression direction of the vehicle 10 that is the approach direction acquired by the approach direction acquisition section 58. The position resulting from offset in such cases is a position P2 (y2) as post offset positional information.

As illustrated in FIG. 6, in a case in which the pedestrian 94 is moving toward the vehicle right side obliquely to the left and in front of the vehicle 10, based on the relative velocity of the pedestrian 94 with respect to the vehicle 10 as acquired by the velocity information acquisition section 56, the offset section 62 offsets the position P1 (x1, y1) acquired by the positional information acquisition section 54 by an offset distance L2 in the oblique direction at an angle with respect to the progression direction of the vehicle 10 as acquired by the approach direction acquisition section 58. The position resulting from offset in such cases is a position P2 (x2, y2) as post offset positional information.

Mark Generation Section

The mark generation section 64 generates the mark M1 (see FIG. 5) urging caution with respect to the target 90 based on the position P2 offset by the offset section 62.

More specifically, in a case in which the vehicle ahead 92 is traveling in a forward direction ahead of the vehicle 10 as illustrated in FIG. 5, the mark generation section 64 generates the mark M1 urging caution with respect to the vehicle ahead 92 at the position P2 (y2) as the post offset positional information offset by the offset section 62.

As illustrated in FIG. 3, the image information of the mark M1 generated by the mark generation section 64 is output to the projection section 51, and an image projected from the projection section 51 is projected onto the third display section 32 of the windshield 22.

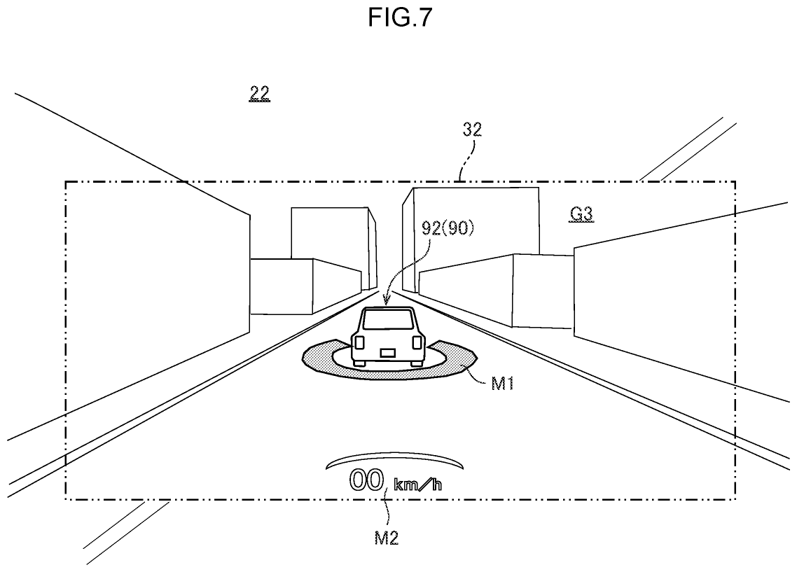

More specifically, in a case in which the vehicle ahead 92 is traveling in a forward direction ahead of the vehicle 10 as illustrated in FIG. 7, the mark M1 is overlay displayed as a virtual image on the third display area G3 of the third display section 32. Namely, the mark M1 is overlay displayed as a virtual image on a forward scene of the windshield 22.

In a case in which the pedestrian 94 is moving toward the vehicle right side obliquely to the left and in front of the vehicle 10 as illustrated in FIG. 6, the mark generation section 64 generates the mark M1 urging caution with respect to the pedestrian 94 at the position P2 (x2, y2) as the post offset positional information offset by the offset section 62.

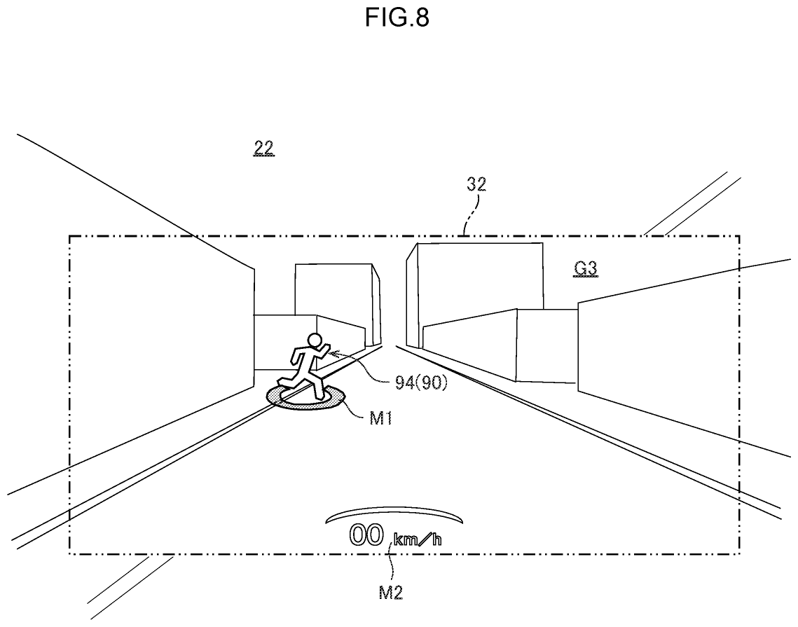

Then, in a case in which the pedestrian 94 is moving toward the vehicle right side obliquely to the left and in front of the vehicle 10 as illustrated in FIG. 8, the mark M1 is overlay displayed as a virtual image on the third display area G3 of the third display section 32. Namely, the mark M1 is overlay displayed as a virtual image on a forward scene of the windshield 22.

The mark generation section 64 may generate a mark to display a velocity V1 of the vehicle 10 and, as illustrated in FIG. 7 and FIG. 8, a second mark M2 to display the velocity V1 of the vehicle 10 may be overlay displayed on the third display area G3 of the third display section 32.

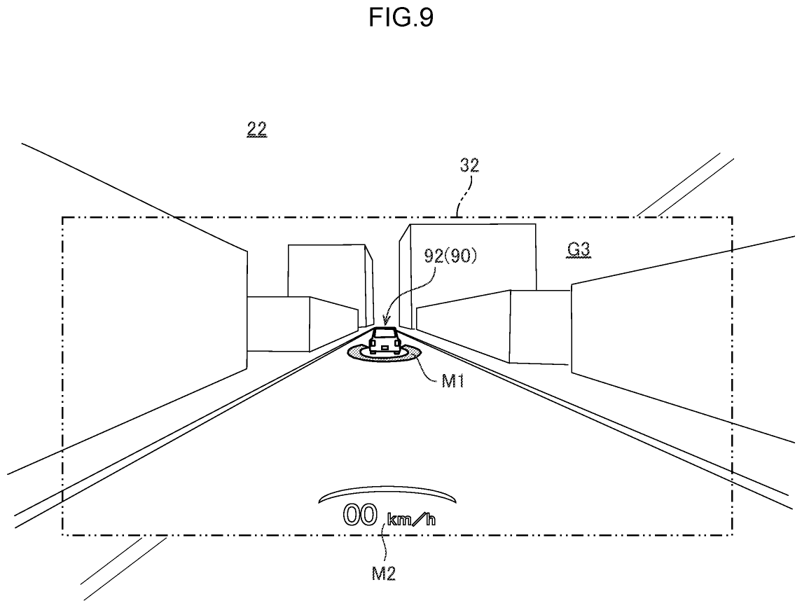

Note that the mark generation section 64 may change the size of the mark M1 based on positional information acquired by the positional information acquisition section 54. More specifically, as illustrated in FIG. 9, the mark generation section 64 is able to make the size of the mark M1 smaller the further the distance of the target 90 from the vehicle 10.

Display Control Device Display Processing Flow

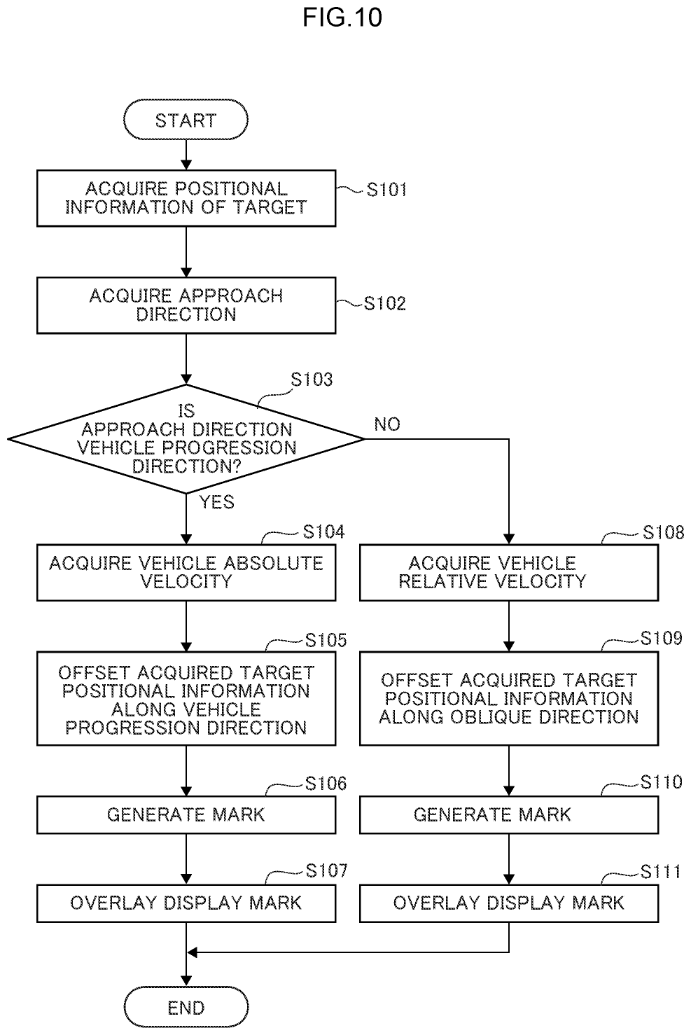

A flow of display processing by the display control device 35 will now be described with reference to the flowchart illustrated in FIG. 10.

As illustrated in FIG. 10, when the display processing has been started, the positional information acquisition section 54 acquires the position P1 of the target 90 based on the detection information of the radar 14 and on the camera image of the camera 12 (step S101).

Next, the approach direction acquisition section 58 acquires the approach direction along which the target 90 approaches the vehicle 10 (step S102).

Next, the display control device 35 determines whether or not the approach direction acquired by the approach direction acquisition section 58 is the progression direction of the vehicle 10 (step S103). When the approach direction acquired by the approach direction acquisition section 58 is the progression direction of the vehicle 10 (step S103: YES), the velocity information acquisition section 56 acquires the velocity V1 that is the absolute velocity of the vehicle 10 based on the measurement information of the vehicle velocity sensor 15 (step S104).

Next, based on the velocity V1 that is the absolute velocity of the vehicle 10 acquired by the velocity information acquisition section 56, the offset section 62 offsets the position P1 acquired by the positional information acquisition section 54 in the vehicle progression direction that is the approach direction acquired by the approach direction acquisition section 58 (step S105). Note that the offset section 62 is able to adjust the offset distance based on the processing time estimated by the processing time estimation section 60.

Next, the mark generation section 64 generates the mark M1 at the position P2 offset by the offset section 62 (step S106).

Next, the information of the mark M1 generated by the mark generation section 64 is output to the projection section 51, the mark M1 is overlay displayed as a virtual image on the third display area G3 of the third display section 32 (step S107), and the display processing is ended.

However, in a case in which at step S103 the approach direction acquired by the approach direction acquisition section 58 is an oblique direction at an angle with respect to the progression direction of the vehicle 10 (step S103: NO), the velocity information acquisition section 56 acquires the relative velocity of the vehicle 10 with respect to the target 90 (step S108).

Next, based on the relative velocity of the vehicle 10 as acquired by the velocity information acquisition section 56, the offset section 62 offsets the position P1 acquired by the positional information acquisition section 54 in the oblique direction that is the approach direction acquired by the approach direction acquisition section 58 (step S109). Note that the offset section 62 is able to adjust the offset distance based on the processing time estimated by the processing time estimation section 60.

Next, the mark generation section 64 generates the mark M1 at the position P2 offset by the offset section 62 (step S110).

Next, the information of the mark M1 generated by the mark generation section 64 is output to the projection section 51, the mark M1 is overlay displayed as a virtual image on the third display area G3 of the third display section 32 (step S111), and the display processing is ended.

### First Exemplary Embodiment Operation and Advantageous Effects

Next, description follows regarding the operation and advantageous effects of the first exemplary embodiment.

The display control device 35 of the first exemplary embodiment includes the positional information acquisition section 54 that acquires positional information related to the position of a target 90 based on at least one of the camera image of the target 90 ahead of the vehicle 10 as imaged by the camera 12 or the detection information of the radar 14 detecting the target 90 ahead of the vehicle 10, includes the velocity information acquisition section 56 that acquires the velocity information related to the velocity of the vehicle 10, includes the approach direction acquisition section 58 that acquires the approach direction along which the target 90 approaches the vehicle 10, includes the offset section 62 that based on the velocity information acquired by the velocity information acquisition section 56 offsets the position P1 acquired by the positional information acquisition section 54 in the approach direction acquired by the approach direction acquisition section 58, and includes the mark generation section 64 that generates the mark M1 to urge caution with respect to the target 90 to overlay display on the third display area G3 provided inside the vehicle cabin at the post offset position P2 after offset by the offset section 62 (see FIG. 4).

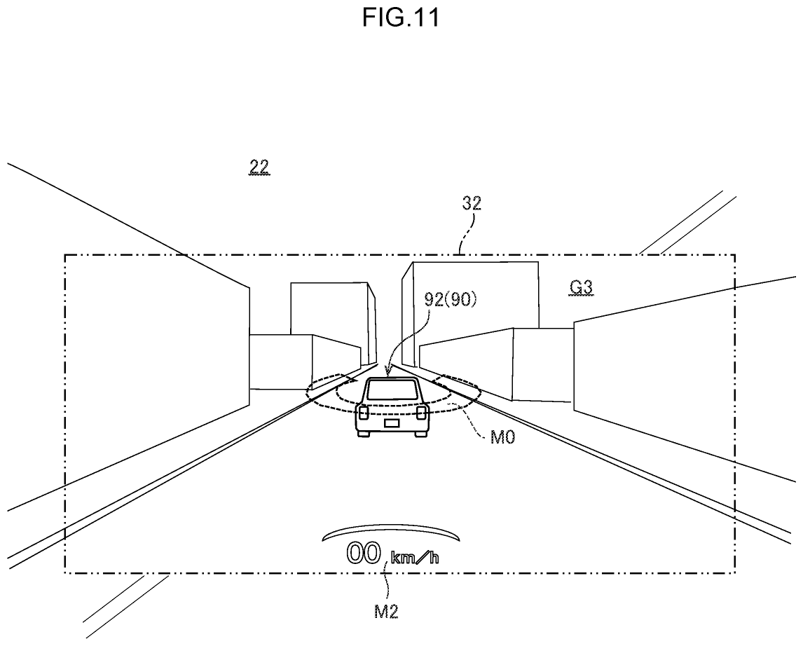

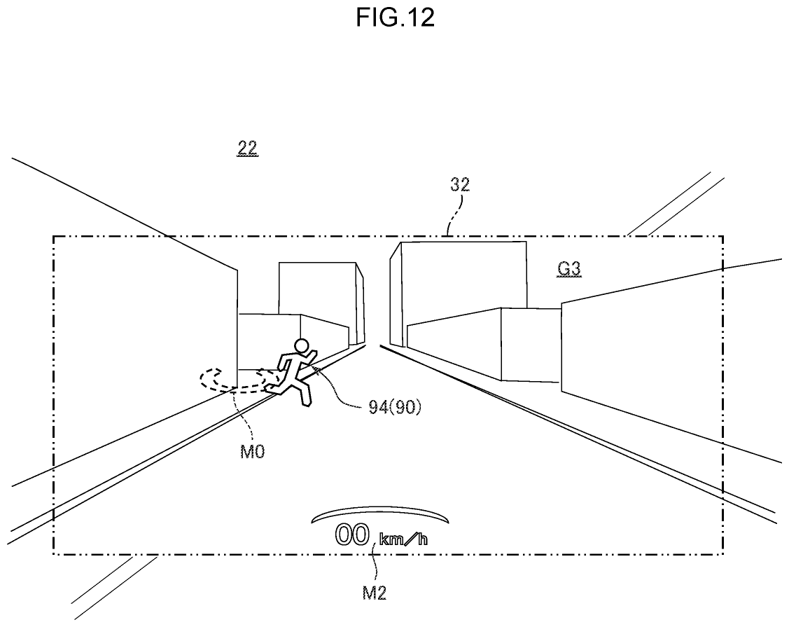

However, processing time is needed for communication, plotting, and the like from when the camera 12 images the target 90 or from when the radar 14 detects the target 90, until the mark generation section 64 generates the mark M1 (see FIG. 5) urging caution with respect to the target 90. This results in a time lag occurring due to the processing time, and as illustrated FIG. 11 and FIG. 12, a problem arises in that a positional misalignment occurs between the position where a mark M0 urging caution with respect to the target 90 is overlay displayed, and the actual position of the target 90. This positional misalignment becomes more significant the faster the travelling velocity of the vehicle 10.

In the first exemplary embodiment, the mark M1 is generated at the position P2 that is the position P1 of the target 90 as acquired by the positional information acquisition section 54 offset based on the velocity information, and the mark M1 urging caution with respect to the target 90 is overlay displayed at the position P2 that is the position of the target 90 acquired by the positional information acquisition section 54 offset according to velocity. This enables correction of the positional misalignment between the overlay displayed mark M1 and the actual target 90, occurring due to the processing time from when the camera 12 images the target 90 or from when the radar 14 detects the target 90 until the mark M1 (see FIG. 5) urging caution with respect to the target 90 is generated by the mark generation section 64.

Moreover, by offsetting the position of the target 90 as acquired by the positional information acquisition section 54 in the approach direction in which the target 90 approaches, the position P1 of the target 90 as acquired by the positional information acquisition section 54 is offset in the direction in which the positional misalignment occurs between the overlay displayed mark M1 and the actual target 90.

This enables the positional misalignment occurring between the position of the overlay displayed mark M1 urging caution with respect to the target 90 and the actual position of the target 90 to be corrected appropriately. As a result thereof, the position of the overlay displayed mark M1 can be brought closer to the actual position of the target 90.

In the display control device 35 of the first exemplary embodiment, in a case in which the approach direction acquired by the approach direction acquisition section 58 is the progression direction of the vehicle 10, the velocity information is velocity V1 that is the absolute velocity of the vehicle 10 (see FIG. 5).

Taking the velocity information as being the absolute velocity of the vehicle 10 means that the velocity information is acquired by detecting the velocity of the vehicle 10. This enables the velocity information to be acquired quicker than cases in which the velocity information is taken as the relative velocity of the vehicle 10 with respect to the target 90. As a result thereof, the time taken for the offset section 62 to offset the position P1 of the target 90 as acquired by the positional information acquisition section 54 can be shortened. Moreover, the load on the CPU installed in the display control device 35 can be lightened.

This means that positional misalignment occurring between the position of the overlay displayed mark M1 urging caution with respect to the target 90 and the actual position of the target 90 can be corrected more appropriately.

In the display control device 35 of the first exemplary embodiment, in a case in which the approach direction acquired by the approach direction acquisition section 58 is an oblique direction at an angle with respect to the progression direction of the vehicle 10, the velocity information is taken as being information related to the relative velocity of the vehicle 10 with respect to the target 90 (see FIG. 6).

By taking the velocity information as being the relative velocity of the vehicle 10 with respect to the target 90, the offset distance for the offset section 62 to offset the position of the target 90 as acquired by the positional information acquisition section 54 is set appropriately based on this relative velocity. This means that positional misalignment occurring between the position of the overlay displayed mark M1 urging caution with respect to the target 90 and the actual position of the target 90 can be corrected more appropriately.

In the display control device 35 of the first exemplary embodiment, the offset section 62 adjusts the offset distance for offsetting the position P1 of the target 90 as acquired by the positional information acquisition section 54 based on the processing time taken from when the camera 12 imaged the target 90 or from when the radar 14 detected the target 90 until the mark generation section 64 generates the mark M1 (see FIG. 5) urging caution with respect to the target 90.

By adjusting the offset distance for offsetting the position P1 of the target 90 as acquired by the positional information acquisition section 54 based on the processing time taken from when the camera 12 imaged the target 90 or from when the radar 14 detected the target 90 until the mark generation section 64 generates the mark M1 (see FIG. 5) urging caution with respect to the target 90, the offset distance is large when the processing time is long, and the offset distance is small when the processing time is short. This means that the offset section 62 sets the offset distance for offsetting the position P1 of the target 90 as acquired by the positional information acquisition section 54 appropriately according to the processing time. As a result thereof, the position of the overlay displayed mark M1 can be corrected to an appropriate position according to the processing time.

In the display control device 35 of the first exemplary embodiment, the positional information acquisition section 54 acquires the vehicle progression direction positional information related to the position of the target 90 in the progression direction of the vehicle based on the detection information of the radar 14, and acquires the vehicle orthogonal direction positional information related to the position of the target 90 in the orthogonal direction orthogonal to the progression direction of the vehicle 10 based on the camera images of the camera 12 (see FIG. 1).

The vehicle progression direction positional information of the target 90 in the progression direction of the vehicle 10 is acquired from the detection information of the radar 14, and the vehicle orthogonal direction positional information of the target 90 in the orthogonal direction orthogonal to the progression direction of the vehicle 10 is acquired based on the camera images of the camera 12. A more accurate positional information of the target 90 is accordingly acquired. As a result thereof, positional misalignment occurring between the position of the overlay displayed mark M1 urging caution with respect to the target 90 and the actual position of the target 90 can be corrected more appropriately.

In the display control device 35 of the first exemplary embodiment, the mark generation section 64 changes the size of the mark M1 based on the position P1 acquired by the positional information acquisition section 54 (see FIG. 9).

By changing the size of the mark M1 based on the position P1 acquired by the positional information acquisition section 54, the size of the mark M1 can be made large when the distance between the vehicle 10 and the target 90 is near, and size of the mark M1 can be made small when the distance between the vehicle 10 and the target 90 is far. This enables a mark M1 of appropriate size according to the distance to the target 90 to be overlay displayed. As a result thereof, the occupant H is able to ascertain the distance to the target 90 from the size of the mark M1.

The display system 16 of the first exemplary embodiment includes the display device 34, the camera 12 for imaging the target 90 ahead of the vehicle 10, and the radar 14 for detecting the target 90 ahead of the vehicle 10 (see FIG. 3).

The display system 16 equipped with the display device 34, the camera 12, and the radar 14 is able to appropriately correct positional misalignment occurring between the position for overlay display of a mark urging caution with respect to a target and the actual position of the target. As a result thereof, the position of the mark for overlay display can be brought closer to the actual position of the target.

The vehicle 10 of the first exemplary embodiment includes the third display area G3 on the windshield 22 (see FIG. 2).

The mark M1 is displayed on the third display area G3 of the windshield 22, and so the occupant H is able to be aware of the mark M1 when in a state gazing forward. The occupant H is accordingly able to be aware of the mark M1 during driving without shifting from the forward gaze.

### Second Exemplary Embodiment

A display system of a second exemplary embodiment differs from the display system of the first exemplary embodiment in that there is a different display area for overlay display of the mark to urge caution with respect to the target.

Description follows regarding a configuration of the display system of the second exemplary embodiment. Note that the same terms and reference numerals are employed in the description for portions that are the same as or substantially equivalent to those described in the content of the first exemplary embodiment.

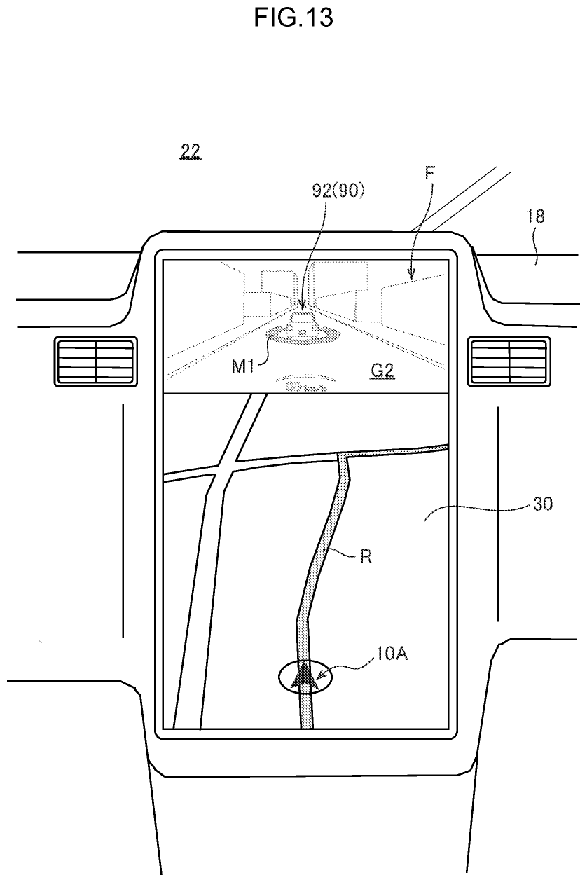

In the second exemplary embodiment, as illustrated in FIG. 13, the mark M1 to urge caution with respect to the target 90 is overlay displayed on a second display area G2 of the second display section 30.

A camera image F imaged by the camera 12 is displayed at an upper side of the second display area G2, and a current position 10A of the vehicle 10 on a map and a route (guidance path) R to a destination is displayed by a navigation system at a lower side of the second display area G2.

Information of an image of the mark M1 generated by the mark generation section 64 is output to the second display section 30 serving as an output section, and the mark M1 is overlay displayed on the second display area G2.

Similar operation and advantageous effects to those of the display system of the first exemplary embodiment can be exhibited even in such a configuration.

This completes a description of a display system of the present disclosure based on the above exemplary embodiments. However, the basic configuration is not limited to those of the exemplary embodiments, and various design modifications and the like are permitted thereto within a scope not departing from the spirit of the present disclosure.

In the exemplary embodiment described above, an example has been illustrated in which the camera 12 images ahead of the vehicle, and the radar 14 detects the positional information of the target 90 ahead of the vehicle. However, the camera and radar are not limited so such a mode, and may image or detect anywhere in the surroundings of the vehicle.

In the exemplary embodiment described above an example was illustrated in which the positional information acquisition section 54 acquired the positional information of the target 90 based on the detection information of the radar 14 and the camera images of the camera 12. However, the positional information acquisition section is not limited to such a mode and, for example, the positional information of the target may be acquired based on at least one detection information from out of radar, camera, LiDAR, or sonar information.

In the exemplary embodiment described above an example was illustrated in which the velocity information acquisition section 56 acquired the relative velocity of the pedestrian 94 with respect to the vehicle 10 based on plural camera images imaged by the camera 12 or plural detection information detected by the radar 14. However, the velocity information acquisition section is not limited to such a mode and, for example, the relative velocity of the target with respect to the vehicle may be acquired based on at least one detection information from out of radar, camera, LiDAR, or sonar information. The velocity information acquisition section may also acquire the relative velocity based on information about inter-vehicle distance.

In the exemplary embodiment described above an example was illustrated in which the approach direction acquisition section 58 acquired the approach direction of the target 90 with respect to the vehicle 10 based on the plural camera images imaged by the camera 12 or on plural detection information detected by the radar 14. However, the approach direction acquisition section 58 is not limited to such a mode and, for example, may acquire the approach direction of the target with respect to the vehicle based on at least one detection information from out of radar, camera, LiDAR, or sonar information.

In the exemplary embodiment described above an example was illustrated in which the offset section 62 adjusted the offset distance for offsetting the position P1 acquired by the positional information acquisition section 54 according to the processing time estimated by the processing time estimation section 60. However, the offset section does not necessarily adjust the offset distance according to the processing time estimated by the processing time estimation section.

In the first exemplary embodiment described above an example was illustrated in which an image of the mark M1 generated by the mark generation section 64 is projected onto the third display section 32 of the windshield 22. In the second exemplary embodiment, an example was illustrated in which an image of the mark M1 generated by the mark generation section 64 is displayed onto the second display section 30. However, the image of the mark generated by the mark generation section may be displayed on the first display section 28, or may be projected onto a combiner provided at an upper face of the instrument panel.

In the exemplary embodiment described above examples were illustrated in which the display system of the present disclosure is applied to a vehicle 10 traveling forward. However, the display system of the present disclosure may be applied to a vehicle traveling around a curve or a vehicle traveling around a street corner.

In the exemplary embodiment described above examples were illustrated in which the processing performed in the display control device 35 was software processing performed by executing by a program, however, there is no limitation thereto. For example, processing performed by hardware may be employed. Or, processing executed by a combination of software and hardware may be employed. Moreover, in a case in which software processing is employed, the program may be distributed stored on various types of non-transitory storage medium such as a compact disc read only memory (CD-ROM), a digital versatile disc read only memory (DVD-ROM), a universal serial bus (USB) memory, or the like, and executed by a processor such as the CPU 36 or the like. The program may also be provided in a format downloadable from an external device over a network.

What is claimed is:

1. A display control device comprising:
a memory; and
a processor coupled to the memory, wherein the processor is configured to:
acquire positional information related to a position of a target based on detection information of the target detected in surroundings of a vehicle;
acquire velocity information related to a velocity of the vehicle;
acquire an approach direction along which the target approaches the vehicle;
offset the positional information in the approach direction based on the velocity information; and
generate a mark urging caution with respect to the target for overlay display on a display area provided in a cabin of the vehicle based on the positional information that has been offset.

2. The display control device of claim 1, wherein the processor is configured such that the velocity information is information related to an absolute velocity of the vehicle in a case in which the acquired approach direction is a progression direction of the vehicle.

3. The display control device of claim 1, wherein the processor is configured such that the velocity information is information related to a relative velocity of the vehicle with respect to the target in a case in which the acquired approach direction is an oblique direction at an angle with respect to a progression direction of the vehicle.

4. The display control device of claim 1, wherein the processor is configured such that an offset distance with which to offset the positional information is adjusted based on a processing time from detection of the target until generation of the mark.

5. The display control device of claim 1, wherein the processor is configured such that vehicle progression direction positional information related to a position of the target in a progression direction of the vehicle is acquired based on detection information of a radar, and vehicle orthogonal direction positional information related to the position of the target in an orthogonal direction orthogonal to the progression direction of the vehicle is acquired based on a camera image of a camera.

6. The display control device of claim 1, wherein the processor is configured such that a size of the mark is changed based on the acquired positional information.

7. A display device comprising:
the display control device of claim 1;
an output section that outputs an image of the mark for overlay display on the display area provided in the vehicle cabin; and
the display area on which the image output from the output section is overlay displayed.

8. A display system comprising:
the display device of claim 7; and
a target detection section that detects the target in the surroundings of the vehicle.

9. A vehicle comprising:
the display system of claim 8; and
a windshield configuring the display area.

10. A display control method executed by a processor, the display control method comprising:
acquiring positional information related to a position of a target based on detection information of a target detection section for detecting the target in surroundings of a vehicle;
acquiring velocity information related to a velocity of the vehicle;
acquiring an approach direction along which the target approaches the vehicle;
offsetting the positional information in the approach direction based on the velocity information; and
generating a mark urging caution with respect to the target for overlay display on a display area provided in a cabin of the vehicle based on the positional information that has been offset.

11. A non-transitory storage medium storing a program executable by a processor to perform display control processing, the display control processing comprising:
acquiring positional information related to a position of a target based on detection information of a target detection section for detecting the target in surroundings of a vehicle;
acquiring velocity information related to a velocity of the vehicle;
acquiring an approach direction along which the target approaches the vehicle;
offsetting the positional information in the approach direction based on the velocity information; and
generating a mark urging caution with respect to the target for overlay display on a display area provided in a cabin of the vehicle based on the positional information that has been offset.
